(19) United States
(12) Patent Application Publication
(10) Pub. No.: US 2021/0048125 A1
(43) Pub. Date: Feb. 18, 2021

(54) HYDRAULIC PIPE COUPLING STRUCTURE THAT IS FORMED INTEGRALLY AND HAS ENHANCED STRENGTH

(71) Applicant: SHIH FENG ENTERPRISE CO., LTD., Fenyuan Township (TW)

(72) Inventor: Chin-Hui Liao, Fenyuan Township (TW)

(21) Appl. No.: 16/542,379

(22) Filed: Aug. 16, 2019

(51) Int. Cl. F16L 13/02; B23K 20/12

(52) U.S. Cl. CPC F16L 13/02; B23K 20/12

(57) ABSTRACT

A hydraulic pipe coupling structure includes a first connector and a second connector. The first connector is provided with a head portion, a first mounting portion, and a through hole. The second connector is provided with a connecting portion and a second mounting portion. A stepped face is formed between the connecting portion and the second mounting portion. The second mounting portion of the second connector extends through the through hole into the first mounting portion of the first connector. The second mounting portion and the stepped face of the second connector are integrally combined with the through hole of the first connector by friction welding, such that the second mounting portion and the stepped face of the second connector, and the through hole of the first connector are welded and integrated.

### BACKGROUND OF THE INVENTION

### 1. Field of the Invention

The present invention relates to a fitting or joint and, more particularly, to a hydraulic pipe coupling structure.

### 2. Description of the Related Art

A conventional hydraulic pipe coupling is manufactured by lathe working and processing. However, it is necessary to remove the redundant material from the hydraulic pipe coupling with a smaller diameter, thereby wasting the material, the working time and the labor work.

Another conventional hydraulic pipe coupling in accordance with the prior art shown in FIGS. 1 and 2 is fabricated by strong clamping (or pressing) and comprises a connector 40, a nut 50, and a fixed sleeve 60. The connector 40 is provided with a connecting portion 43, a first annular groove 41, and a second annular groove 42. The nut 50 is provided with a first mounting portion 51 mounted on the connector 40. The first mounting portion 51 of the nut 50 has an interior provided with a first engaging section 52 secured in the first annular groove 41 of the connector 40. The fixed sleeve 60 is provided with a second mounting portion 61 mounted on the connector 40. The second mounting portion 61 of the fixed sleeve 60 has an interior provided with a second engaging section 62 secured in the second annular groove 42 of the connector 40. After the first mounting portion 51 of the nut 50 is mounted on the connector 40, the first engaging section 52 of the nut 50 is deformed inward by strong clamping or pressing, such that the first engaging section 52 of the nut 50 engages the first annular groove 41 of the connector 40. After the second mounting portion 61 of the fixed sleeve 60 is mounted on the connector 40, the second engaging section 62 of the fixed sleeve 60 is deformed inward by strong clamping or pressing, such that the second engaging section 62 of the fixed sleeve 60 engages the second annular groove 42 of the connector 40. However, the structural strength of the hydraulic pipe coupling is reduced by the strong clamping, such that the conventional hydraulic pipe coupling cannot withstand a high pressure, and easily produces leakage through the gap between the first engaging section 52 of the nut 50 and the first annular groove 41 of the connector 40, and the gap between the second engaging section 62 of the fixed sleeve 60 and the second annular groove 42 of the connector 40.

### BRIEF SUMMARY OF THE INVENTION

The primary objective of the present invention is to provide a hydraulic pipe coupling structure that is formed integrally and has an enhanced strength.

In accordance with the present invention, there is provided a hydraulic pipe coupling structure comprising a first connector, and a second connector connected with the first connector. The first connector has a first end provided with a head portion and a second end provided with a first mounting portion. The first connector has an interior provided with a through hole. The through hole of the first connector has an inner diameter smaller than that of the first mounting portion. The second connector has an interior provided with an axial hole. The second connector has a first end provided with a connecting portion and a second end provided with a second mounting portion. The connecting portion of the second connector has an outer diameter greater than that of the second mounting portion. A stepped face is formed between the connecting portion and the second mounting portion. The second mounting portion of the second connector corresponds to the first mounting portion of the first connector. The second mounting portion of the second connector has an outer diameter equal to the inner diameter of the through hole of the first connector. The second mounting portion of the second connector extends through the through hole into the first mounting portion of the first connector. The second mounting portion and the stepped face of the second connector are integrally combined with the through hole of the first connector by friction welding, such that the second mounting portion and the stepped face of the second connector, and the through hole of the first connector are welded and integrated.

According to the primary advantage of the present invention, the first connector and the second connector are formed and combined integrally by friction welding, such that the hydraulic pipe coupling structure has reinforced strength and has greater concentricity.

According to another advantage of the present invention, the first connector and the second connector are combined integrally, without needing lathe processing, so as to save the cost of material, the working time, and the labor work.

According to a further advantage of the present invention, the first connector and the second connector are combined closely, to withstand a high pressure, to prevent from incurring an oil leak, and to provide an air-tight effect.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 includes multiple exploded perspective operational views showing successive assembling procedures of a conventional hydraulic pipe coupling in accordance with the prior art.

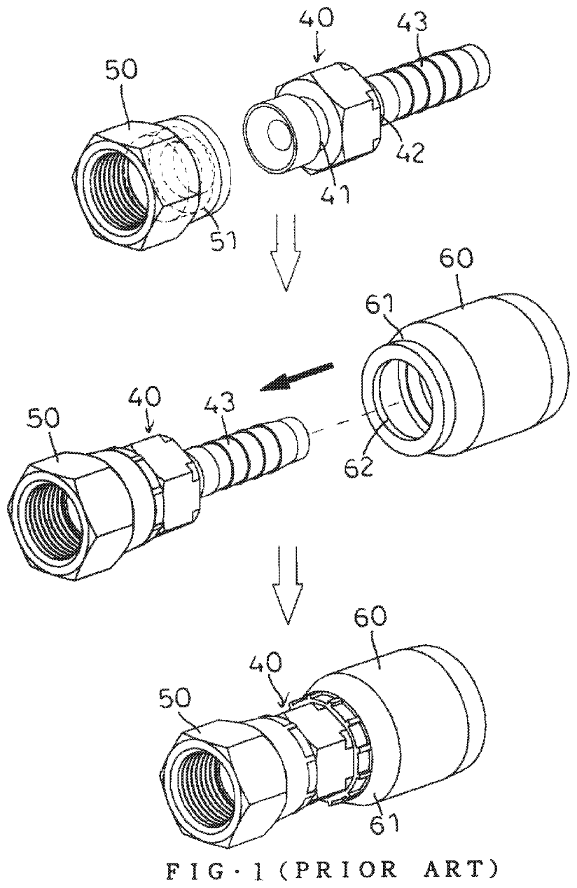

FIG. 2 is a cross-sectional assembly view of the conventional hydraulic pipe coupling in accordance with the prior art.

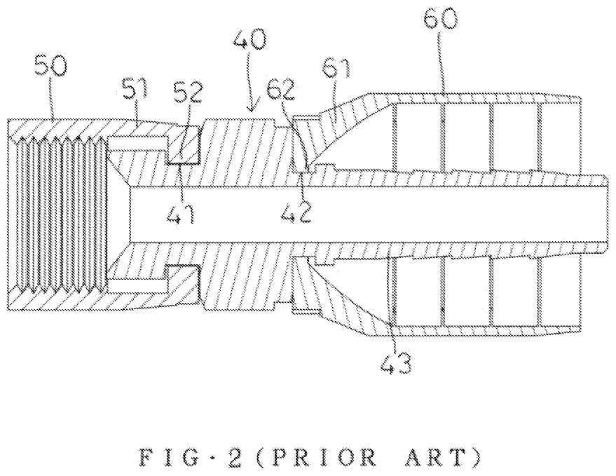

FIG. 3 is an exploded perspective view of a hydraulic pipe coupling structure in accordance with the first preferred embodiment of the present invention.

FIG. 4 is a perspective assembly cross-sectional view of the hydraulic pipe coupling structure in accordance with the first preferred embodiment of the present invention.

FIG. 5 includes cross-sectional views showing multiple successive assembling procedures of the first connector and the second connector of the hydraulic pipe coupling structure in accordance with the first preferred embodiment of the present invention.

FIG. 6 includes cross-sectional views showing multiple successive assembling procedures of the second connector and the nut of the hydraulic pipe coupling structure in accordance with the first preferred embodiment of the present invention.

FIG. 7 is a perspective assembly cross-sectional view of the hydraulic pipe coupling structure in accordance with the second preferred embodiment of the present invention.

FIG. 8 includes cross-sectional views showing multiple successive assembling procedures of the first connector and the second connector of the hydraulic pipe coupling structure in accordance with the second preferred embodiment of the present invention.

FIG. 9 is a cross-sectional view of the hydraulic pipe coupling structure as shown in FIG. 7.

FIG. 10 is a perspective view of the hydraulic pipe coupling structure in accordance with the second preferred embodiment of the present invention.

### DETAILED DESCRIPTION OF THE INVENTION

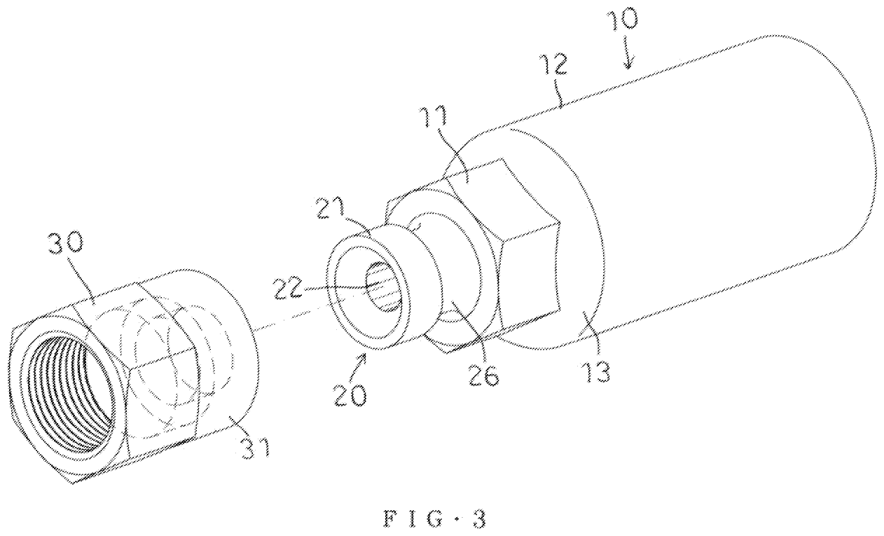

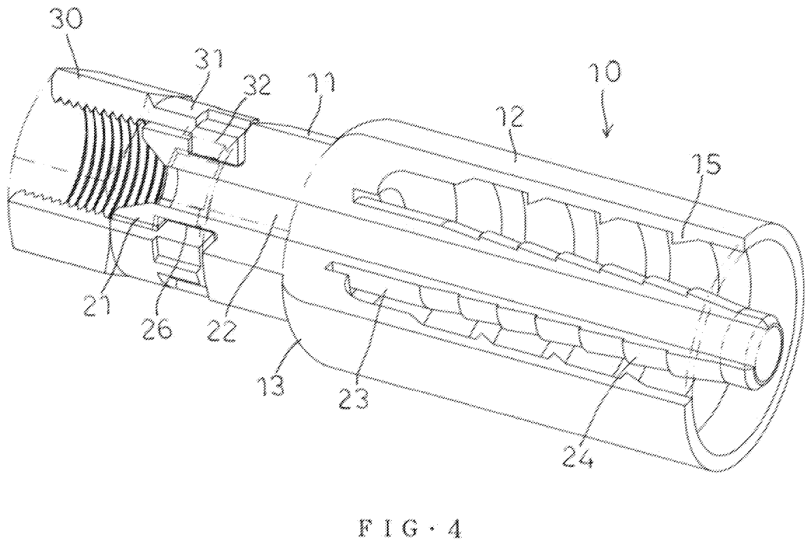

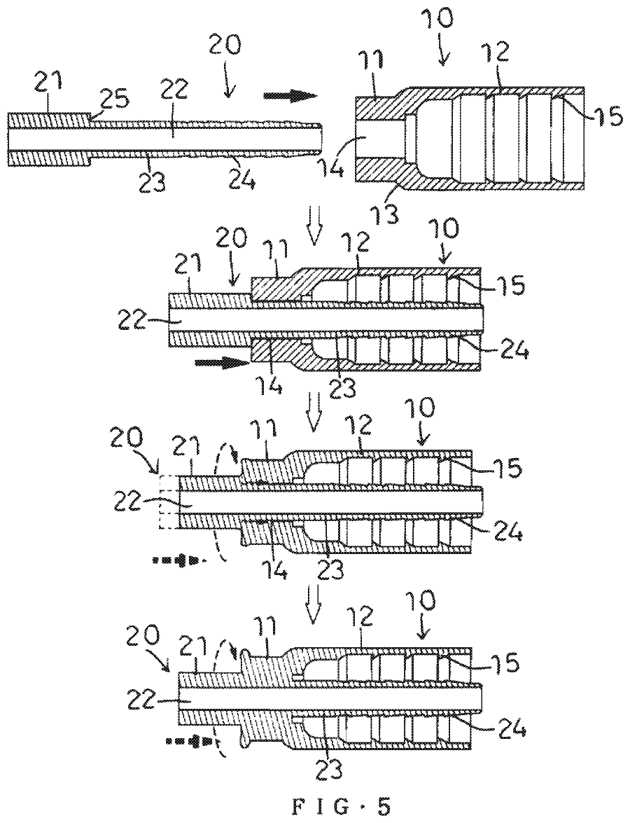

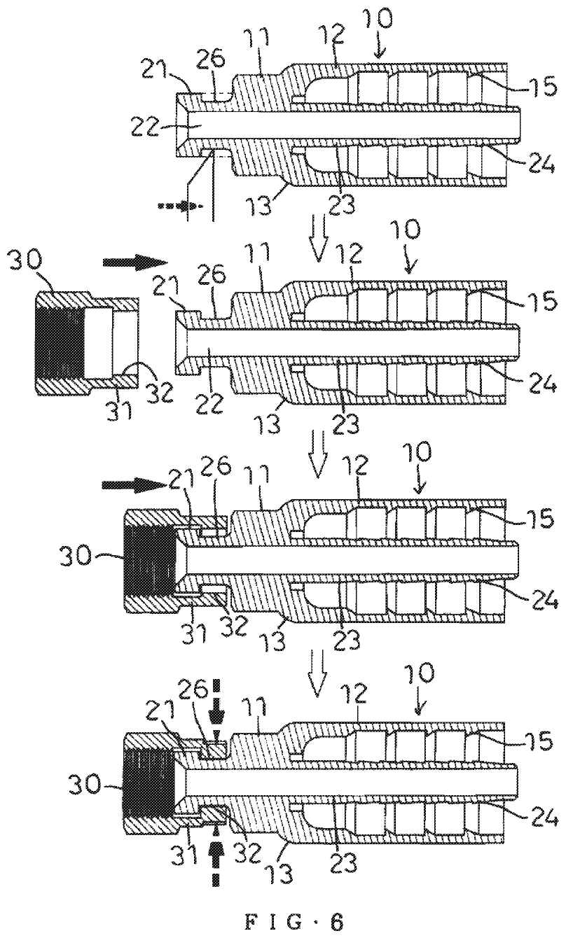

Referring to the drawings and initially to FIGS. 3-6, a hydraulic pipe coupling structure in accordance with the preferred embodiment of the present invention comprises a first connector 10, and a second connector 20 connected with the first connector 10.

The first connector 10 has a first end provided with a head (or fixed or driven) portion 11 and a second end provided with a first mounting portion 12 which is enlarged. The first connector 10 has an interior provided with a through hole 14 which is arranged at a center of the head portion 11. The through hole 14 of the first connector 10 has an inner diameter smaller than that of the first mounting portion 12.

The second connector 20 has an interior provided with an axial hole 22 which is arranged at a center of the second connector 20. The second connector 20 has a first end provided with a connecting portion 21 and a second end provided with a second mounting portion 23. The connecting portion 21 of the second connector 20 has an outer diameter greater than that of the second mounting portion 23, and a stepped face 25 is formed between the connecting portion 21 and the second mounting portion 23. The second mounting portion 23 of the second connector 20 corresponds to the first mounting portion 12 of the first connector 10. The second mounting portion 23 of the second connector 20 has an outer diameter equal to the inner diameter of the through hole 14 of the first connector 10. The second mounting portion 23 of the second connector 20 extends through the through hole 14 into the first mounting portion 12 of the first connector 10, such that the second mounting portion 23 of the second connector 20 is arranged in the first mounting portion 12 of the first connector 10. The stepped face 25 of the second connector 20 rests on the head portion 11 of the first connector 10 and is juxtaposed to the through hole 14 of the first connector 10. The second mounting portion 23 and the stepped face 25 of the second connector 20 are integrally combined with the through hole 14 of the first connector 10 by friction welding, such that the second mounting portion 23 and the stepped face 25 of the second connector to 20, and the through hole 14 of the first connector 10 are welded and integrated.

In fabrication, the head portion 11 of the first connector 10 is fixed by a wrench (not shown), to prevent the first connector 10 from being rotated. Thus, the first connector 10 is fixed, and the second connector 20 contacts with and is revolved relative to the first connector 10 at a high speed, such that the second mounting portion 23 of the second connector 20, the stepped face 25 of the second connector 20, and the through hole 14 of the first connector 10 are rubbed to produce heat, and are welded together to form an integrity. Then, the weld dregs (or slag) are ground and cleared after the welding process is finished.

In the preferred embodiment of the present invention, the first mounting portion 12 of the first connector 10 has an interior provided with a plurality of first anti-reverse portions 15, and the second mounting portion 23 of the second connector 20 has an exterior provided with a plurality of second anti-reverse portions 24. Thus, when a hydraulic pipe (not shown) is inserted into the first connector 10, the first anti-reverse portions 15 of the first mounting portion 12, and the second anti-reverse portions 24 of the second mounting portion 23 engage the hydraulic pipe in a oneway direction, to allow the hydraulic pipe moving forward and to prevent the hydraulic pipe from being moved backward, such that the hydraulic pipe is inserted into the first connector 10, and cannot be pulled outward or detached from the first connector 10.

In the preferred embodiment of the present invention, the hydraulic pipe coupling structure further comprises a nut 30 mounted on the connecting portion 21 of the second connector 20.

In the preferred embodiment of the present invention, the first connector 10 is formed integrally with the head portion 11 by forging, and the head portion 11 of the first connector 10 has a polygonal or hexagonal shape.

In the preferred embodiment of the present invention, the head portion 11 of the first connector 10 has an outer diameter smaller than that of the first mounting portion 12, and an arcuate reduced neck 13 is formed between the head portion 11 and the first mounting portion 12 of the first connector 10.

In the preferred embodiment of the present invention, the connecting portion 21 of the second connector 20 is provided with a reduced neck portion 26 for mounting the nut 30. The nut 30 is provided with a fitting portion 31 mounted on the connecting portion 21 of the second connector 20. The fitting portion 31 of the nut 30 has an interior provided with an engaging section 32 engaging the reduced neck portion 26 of the connecting portion 21 of the second connector 20. In fabrication, when the fitting portion 31 of the nut 30 is mounted on the connecting portion 21 of the second connector 20, the engaging section 32 of the nut 30 is deformed inward by strong clamping (or engaging or pressing), such that the engaging section 32 of the nut 30 and the reduced neck portion 26 of the second connector 20 are combined integrally.

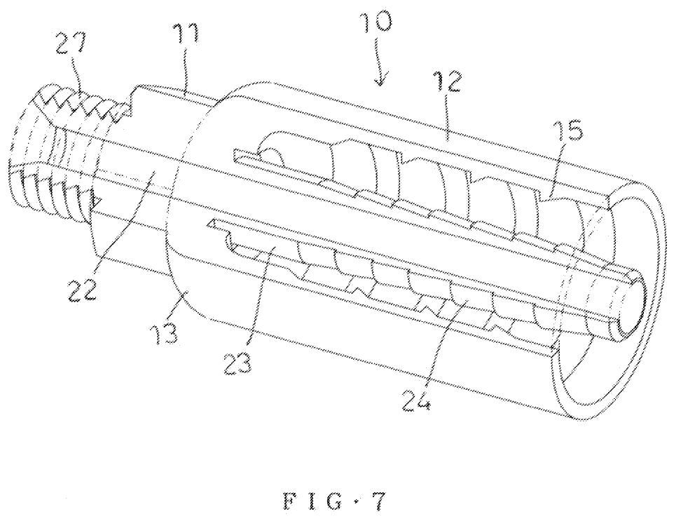

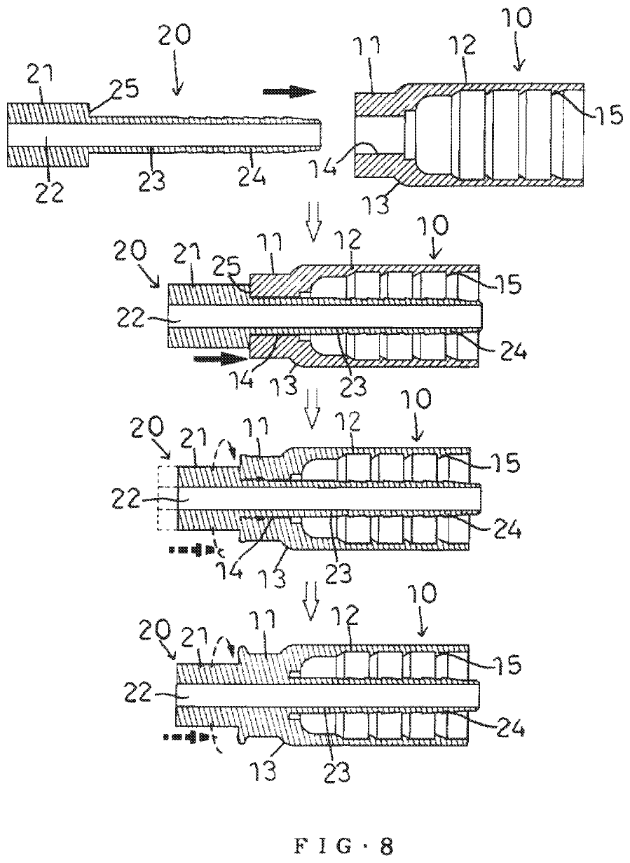

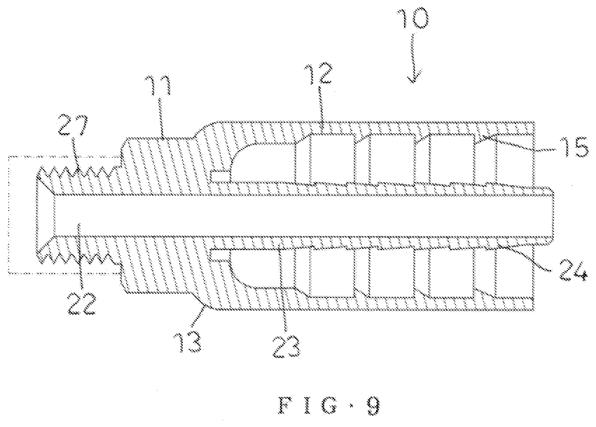

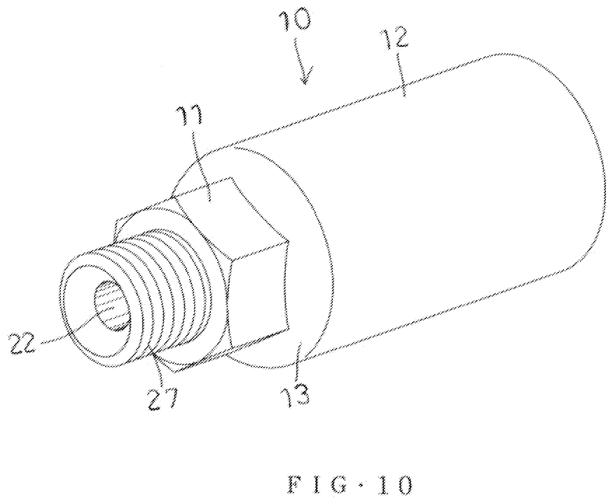

Referring to FIGS. 7-10 with reference to FIGS. 3-6, the hydraulic pipe coupling structure in accordance with another preferred embodiment of the present invention only comprises the first connector 10 and the second connector 20. The nut 30 is undefined. The connecting portion 21 of the second connector 20 is provided with an external thread 27.

Accordingly, the first connector 10 and the second connector 20 are formed and combined integrally by friction welding, such that the hydraulic pipe coupling structure has reinforced strength and has greater concentricity. In addition, the first connector 10 and the second connector 20 are combined integrally, without needing lathe processing, so as to save the cost of material, the working time, and the labor work. Further, the first connector 10 and the second connector 20 are combined closely, to withstand a high pressure, to prevent from incurring an oil leak, and to provide an air-tight effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A hydraulic pipe coupling structure comprising:
a first connector; and
a second connector connected with the first connector;
wherein:
the first connector has a first end provided with a head portion and a second end provided with a first mounting portion;
the first connector has an interior provided with a through hole;
the through hole of the first connector has an inner diameter smaller than that of the first mounting portion;
the second connector has an interior provided with an axial hole;
the second connector has a first end provided with a connecting portion and a second end provided with a second mounting portion;
the connecting portion of the second connector has an outer diameter greater than that of the second mounting portion;
a stepped face is formed between the connecting portion and the second mounting portion;
the second mounting portion of the second connector corresponds to the first mounting portion of the first connector;
the second mounting portion of the second connector has an outer diameter equal to the inner diameter of the through hole of the first connector;
the second mounting portion of the second connector extends through the through hole into the first mounting portion of the first connector; and
the second mounting portion and the stepped face of the second connector are integrally combined with the through hole of the first connector by friction welding, such that the second mounting portion and the stepped face of the second connector, and the through hole of the first connector are welded and integrated.

2. The hydraulic pipe coupling structure of claim 1, wherein the first mounting portion of the first connector has an interior provided with a plurality of first anti-reverse portions, and the second mounting portion of the second connector has an exterior provided with a plurality of second anti-reverse portions.

3. The hydraulic pipe coupling structure of claim 1, wherein the connecting portion of the second connector is provided with an external thread.

4. The hydraulic pipe coupling structure of claim 1, further comprising:
a nut mounted on the connecting portion of the second connector.

5. The hydraulic pipe coupling structure of claim 1, wherein the first connector is formed integrally with the head portion by forging, and the head portion of the first connector has a polygonal or hexagonal shape.
